(19) United States
(12) Patent Application Publication
(10) Pub. No.: US 2006/0106926 A1
(43) Pub. Date: May 18, 2006

(54) System and program for detecting disk array device bottlenecks

(75) Inventors: Tadaomi Kato, Kawasaki (JP); Keiko Hiyoshi, Yokohama (JP); Juichi Sakai, Kawasaki (JP); Naoki Hirabayashi, Kawasaki (JP); Takaaki Yamato, Kawasaki (JP); Tomonari Horikoshi, Kawasaki (JP)

Correspondence Address: Patrick G. Burns;GREER, BURNS & CRAIN, LTD., Suite 2500, 300 South Wacker Drive, Chicago, IL, 60606, US

(73) Assignee: FUJITSU LIMITED

(21) Appl. No.: 11/321,578

(22) Filed: Dec. 29, 2005

Related U.S. Application Data
(63) Continuation of application No. PCT/JP03/10425, filed on Aug. 19, 2003.
(63) Continuation of application No. PCT/JP04/11780, filed on Aug. 17, 2004.

(51) Int. Cl. G06F 15/173

(52) U.S. Cl. 709/223

(57) ABSTRACT

A system is provided in which a server which provides a service to a client terminal, a disk array device upon which data used by the server is stored, and a monitor terminal which detects a bottleneck on the disk array device, are connected via a network. The disk array device or the server calculates performance information including the number of IO requests issued by the server, the times required for processing the IO requests, and a resource utilization ratio for each resource included in the disk array device. The monitor terminal establishes a reference point based upon an average response time obtained by dividing the processing time included in the performance information by the number of the IO requests. And the system is characterized in that a resource is identified as a bottleneck, based upon the resource utilization ratio in a predetermined interval before the reference point.

### CROSS REFERENCE TO RELATED APPLICATIONS

This application is a continuation of International Application No. PCT/JP03/10425, filed on Aug. 19, 2003, and International Application No. PCT/JP2004/011780, filed on Aug. 17, 2004, now pending, herein incorporated by reference.

### TECHNICAL FIELD

The present invention relates to a system which includes a disk array device and a server which performs input and output of data to and from this disk array device.

### BACKGROUND ART

A system in which a server which provides services to client terminals via a network, and a disk array device which stores various types of data used by application programs operating upon this server, are connected together, is widely used as a current business system. When, with this type of system, the time period accompanying the processing of an application becomes great, the service which is provided to the client terminals deteriorates undesirably. Accordingly, various types of information (performance information) related to the performance of the system are monitored, such as the time period accompanying the processing of applications becoming greater than a fixed reference, and a procedure is executed of detecting whether or not spots (bottlenecks) which can become causes of the processing of applications slowing down are occurring; and, if a bottleneck has been detected, the bottleneck is identified, and a bottleneck elimination procedure is performed upon this bottleneck.

As bottlenecks related to the disk array device, there are the resource consisting of a CPU within the disk array device, the resource consisting of the physical disk, and the like. In the past, detection and identification of bottlenecks upon the disk array device were executed together, and a resource utilization ratio was utilized which was calculated by dividing the cumulative value of the time over which a resource was being used during a predetermined time period, by that predetermined time period; and, if the resource utilization ratio exceeded a threshold value, that resource was determined to be a bottleneck.

However there are cases in which, when the resource utilization ratio rises, this does not necessarily correspond to the occurrence of a bottleneck. As an example, a case in which the disk has been selected as a resource will now be explained.

FIG. 1 is a figure for explanation of the disk utilization ratio accompanying the processing of an application and the generation of a bottleneck. The vertical axis shows the elapsed time 11, while the horizontal axis shows the time periods 12 (the response time) which are required for processing input and output (IO) requests such as writing, reading, and the like issued by the server along with the processing of the application. FIG. 1A shows the case when the IO requests arrive bunched together at some time, while FIG. 1B shows the case when the IO requests arrive comparatively uniformly.

In FIG. 1A, there is shown an example of the occurrence of a bottleneck as the result of the arrival of more IO requests than the processing capability of the disk array device, bunched together in a short time period. Since the IO requests arrive one after the other before the processing of one IO request can be completed, more time is required for the processing of the IO requests which arrive subsequently. In FIG. 1B, the IO requests are processed satisfactorily, and the occurrence of a bottleneck is not observed.

When both the average response time, obtained by dividing the cumulative value of the response time in a predetermined time period by the number of IO requests which have arrived, and the disk utilization ratio, which is the proportion within this predetermined time period of the cumulative time period obtained by totaling the time periods the disk has been used, are calculated, in FIG. 1A the average response time is 35 ms and the disk utilization ratio is 53%, while, by contrast, in FIG. 1B the average response time is 14 ms and the disk utilization ratio is 67% .

However, with a conventional method in which bottlenecks are detected by monitoring the resource utilization ratio, if the threshold value of the disk utilization ratio has been set to 60%, then, in the case of FIG. 1B, detection of the disk as a bottleneck will take place. However, in the case of FIG. 1B, it is not actually necessary to perform any bottleneck elimination procedure; the case in which a bottleneck elimination procedure is required is that of FIG. 1A. It may be mentioned that, also in the case of monitoring, as a resource, the CPU or some resource other than the disk, the same situation as in FIG. 1 holds with regard to the resource utilization ratio and the response time.

By the way, as a related conventional technique, there is a disk array device which cancels IO requests (Patent Reference #1), and the like.

Patent Reference #1:

Japanese Patent Application Laid-open No. 2000-215007

### DISCLOSURE OF THE INVENTION

In this manner, with conventional methods of detecting and identifying bottlenecks only on the basis of resource utilization ratio, there have been the problems that sometimes a bottleneck which ought to be eliminated is overlooked, and that sometimes a bottleneck elimination procedure is performed for a bottleneck which is not actually occurring.

Thus, an object of the present invention is to provide a system and a program, which are capable of appropriately detecting the occurrence of bottlenecks.

The above described object is attained by providing a system as described in Claim 1, which is a system comprising a server which provides a service to a client terminal via a network, a disk array device connected to the server and to the network and upon which data used by the server is stored, and a monitor terminal connected to the disk array device via the network, which detects a bottleneck on the disk array device; characterized in that: the disk array device or the server calculates and periodically notifies to the monitor terminal performance information including the number of IO requests issued from the server to the disk array device, the times required for processing the IO requests, and a resource utilization ratio for each resource included in the disk array device; and the monitor terminal takes, as a reference point, a time point at which an interval, in which an average response time obtained by dividing the processing time included in the periodically notified performance information by the number of the IO requests exceeds a first threshold value, exceeds a first predetermined interval; and identifies the resource as a bottleneck, if the proportion of intervals included in a second predetermined interval before the reference point, in which the resource utilization ratio exceeds a second threshold value set for each the resource, exceeds a predetermined proportion.

Furthermore, the above described object is attained by providing a system as described in Claim 2, which is the system of Claim 1, characterized in that the monitor terminal takes, as the reference point, the time point at which the interval, in which the average response time exceeds the first threshold value, continuously exceeds the first predetermined interval.

Furthermore, the above described object is attained by providing a system as described in Claim 3, which is the system of Claim 1, characterized in that the monitor terminal takes, as the reference point, the time point at which the result of accumulating for a third predetermined interval the intervals in which the average response time exceeds the first threshold value, exceeds the first predetermined interval.

Furthermore, the above described object is attained by providing a system as described in Claim 4, which is the system of Claim 3, characterized in that the monitor terminal obtains the accumulated result for each the third predetermined interval.

Furthermore, the above described object is attained by providing a system as described in Claim 5, which is the system of Claim 3, characterized in that the monitor terminal obtains the accumulated result over a space which is shorter than the third predetermined interval.

Furthermore, the above described object is attained by providing a system as described in Claim 6, which is the system of Claim 3, characterized in that the monitor terminal resets back the cumulative interval to zero, if the average response time within the third predetermined interval has dropped below a third threshold value which is lower than the first threshold value.

Furthermore, the above described object is attained by providing a system as described in Claim 7, which is the system of Claim 1, characterized in that the monitor terminal identifies the resource as a bottleneck, if the proportion of intervals, included in a fourth predetermined interval which is an interval before the reference point and moreover in which the average response time exceeds a fourth threshold value, and in which the resource utilization ratio exceeds the second threshold value set for each of the resources, exceeds the predetermined proportion.

Furthermore, the above described object is attained by providing a program as described in Claim 8, which is a program executed by a terminal comprised in a system comprising a server which provides a service to a client terminal via a network, and a disk array device connected to the server and to the network and upon which data used by the server is stored, and connected to the disk array device via the network; characterized in that: the program causes the terminal: to receive performance information, periodically notified by the server or the disk array device, including the number of IO requests issued from the server to the disk array device, the times required for processing the IO requests, and a resource utilization ratio for each resource included in the disk array device; and to identify the resource as a bottleneck, with a time point at which an interval, in which an average response time, obtained by dividing the processing time included in the received performance information by the number of the IO requests, exceeds a first threshold value, exceeds a first predetermined interval, being taken as a reference point, if the proportion of intervals included in a second predetermined interval before the reference point, in which the resource utilization ratio exceeds a second threshold value set for each the resource, exceeds a predetermined proportion.

Furthermore, the above described object is attained by providing a system which is a system comprising a server which provides a service to a client terminal via a network, a disk array device connected to the server and to the network and upon which data used by the server is stored, and a monitor terminal connected to the disk array device via the network, which detects a bottleneck on the disk array device; characterized in that: the disk array device or the server calculates and periodically notifies to the monitor terminal performance information including the number of IO requests issued from the server to the disk array device, the times required for processing the IO requests, and a resource utilization ratio for each resource included in the disk array device; and the monitor terminal determines a time to become a reference point, based upon an interval in which an average response time, obtained by dividing the processing time included in the periodically notified performance information by the number of the IO requests, exceeds a first threshold value, and identifies the resource as a bottleneck, if the proportion of intervals included in a first predetermined interval before the reference point, in which the resource utilization ratio exceeds a second threshold value set for each the resource, exceeds a predetermined proportion.

According to a preferred embodiment, the reference point is a time point at which the interval in which the average response time exceeds the first threshold value continuously exceeds a second predetermined interval. Furthermore, the reference point may be the time point at which the cumulative total, for a third predetermined interval, of the intervals in which the average response time exceeds the first threshold value, exceeds the second predetermined interval. Moreover, the reference point may be taken as the time point where, in an interval in which the average response time continuously exceeds the first threshold value, and arranging time on the horizontal axis and the average response time on the vertical axis, the area of a portion surrounded by a waveform obtained by plotting the average response time with respect to the time, and by a horizontal line showing the average response time having the first threshold value, exceeds a predetermined area. Further, the reference point may be the time point where the total of accumulating, for a third predetermined interval, the areas of portions surrounded by a waveform obtained by plotting the average response time with respect to the time, and by a horizontal line showing the average response time having the first threshold value, exceeds a predetermined area.

Furthermore, the above described object is attained by providing a program which is a program executed by a terminal comprised in a system comprising a server which provides a service to a client terminal via a network, and a disk array device connected to the server and to the network and upon which data used by the server is stored, and connected to the disk array device via the network; characterized in that the program causes the terminal: to receive performance information, periodically notified by the server or the disk array device, including the number of IO requests issued from the server to the disk array device, the times required for processing the IO requests, and a resource utilization ratio for each resource included in the disk array device; to determine a time to become a reference point, based upon an interval in which an average response time, obtained by dividing the processing time included in the received performance information by the number of the IO requests, exceeds a first threshold value, and to identify the resource as a bottleneck, if the proportion of intervals included in a first predetermined interval before the reference point, in which the resource utilization ratio exceeds a second threshold value set for each the resource, exceeds a predetermined proportion.

By performing the detection of bottlenecks based upon the response time, and by using, as an identification condition, the resource utilization ratio, which is different from the response time, it is possible to perform identification of bottlenecks according to two standards, so that it is possible to perform the detection of bottlenecks more appropriately than conventionally.

### BRIEF DESCRIPTION OF THE DRAWINGS

FIG. 1 is a figure for explanation of a disk utilization ratio and the occurrence of a bottleneck accompanying the processing of an application;

FIG. 2 is a figure showing an example of the overall structure of a system according to an embodiment of the present invention;

FIG. 3 is a figure showing an example of the structure of a server;

FIG. 4 is a figure showing an example of the structure of a disk array device;

FIG. 5 is a flow chart for explanation of a bottleneck detection method of an embodiment of the present invention;

FIG. 6 is a figure for explanation of a first reference point condition;

FIG. 7 is a figure for explanation of a second reference point condition;

FIG. 8 is a variant example of a cumulative interval calculation method;

FIG. 9 is a figure for explanation of an example of an interval over which a cumulative interval is calculated;

FIG. 10 is a figure for explanation of a first bottleneck identification condition;

FIG. 11 is a figure for explanation of a second bottleneck identification condition;

FIG. 12 is a figure for explanation of a third reference point condition; and

FIG. 13 is a figure for explanation of a fourth reference point condition.

### BEST MODE FOR CARRYING OUT THE INVENTION

In the following, embodiments of the present invention will be explained with reference to the figures. However, the technical range of the present invention is not limited to these embodiments.

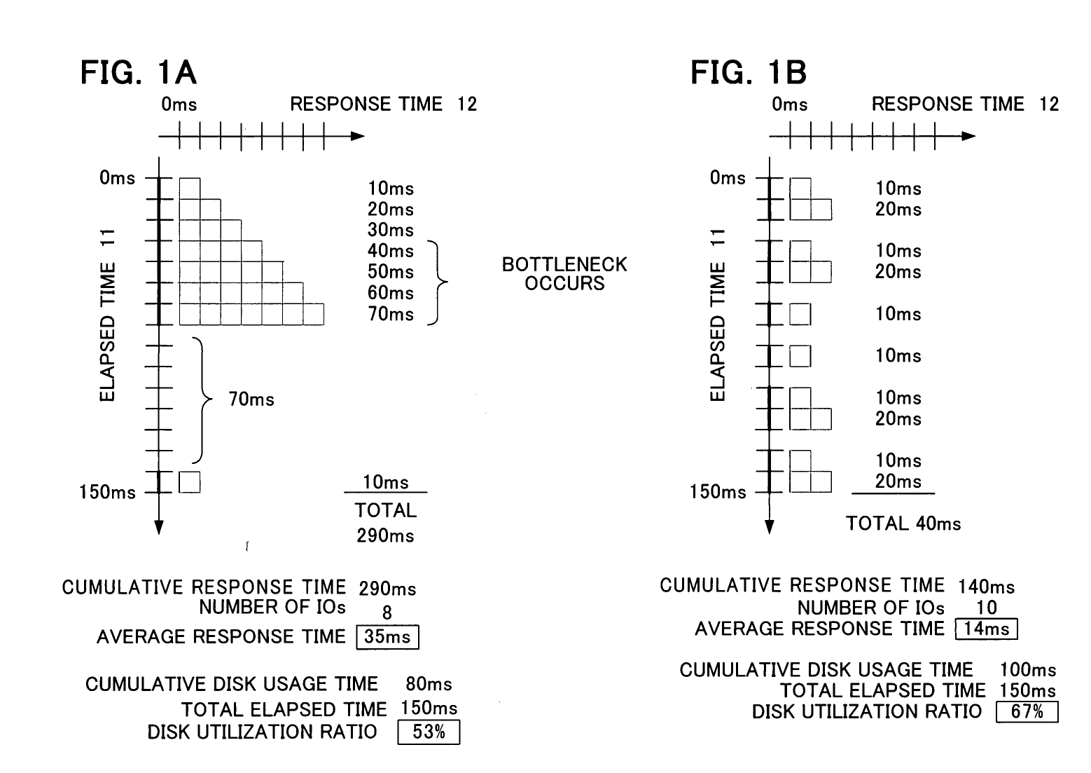

As shown in FIG. 1, when a bottleneck occurs, the response time which is required for the processing of IO requests increases. Accordingly, in order to detect the occurrence of bottlenecks, it should be sufficient to monitor the response time. Thus, in the embodiments of the present invention, it is not the case that the resource utilization ratio is monitored, and bottlenecks are detected from the resource utilization ratio, as in the prior art; rather, a reference point for the detection of bottlenecks is determined based upon a condition which is set in relation to the response time. And the history of the performance information before the reference point is referred to, and bottlenecks are identified based upon an identification condition which is set in relation to the resource utilization ratio.

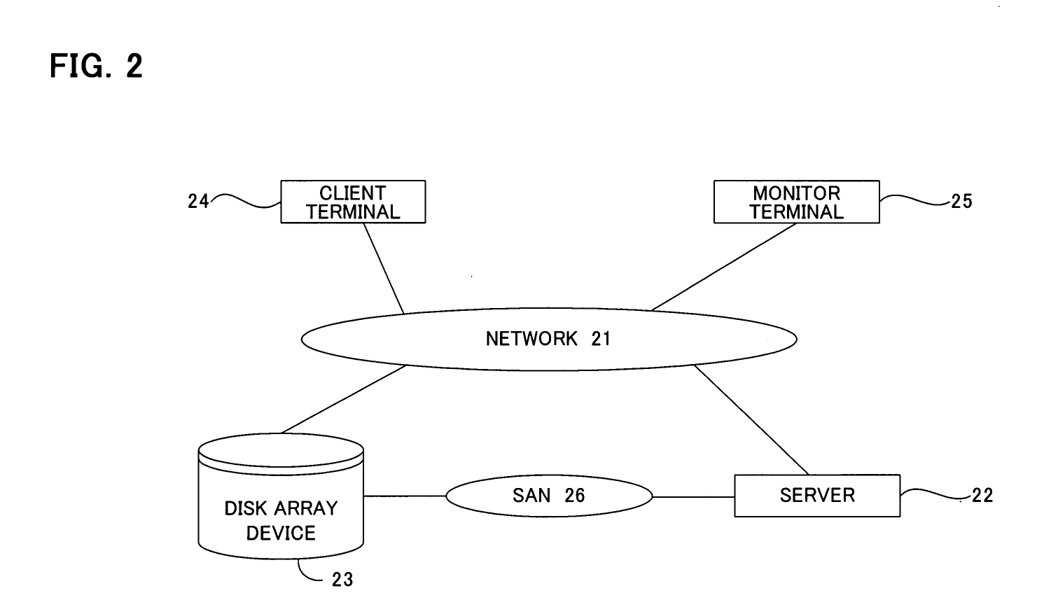

FIG. 2 is a figure showing an example of the general structure of a system which is an embodiment of the present invention. A server 22 provides services to a client terminal 24 via a network 21. Corresponding to the application which operates upon the server 22, various services may be provided, such as a web server, a mail server, a database server, or the like. A monitor terminal 25 is a terminal for monitoring the operational states of the server 22 and of a disk array device 23.

Various data used by the above described applications is stored in the disk array device 23, which is connected to the server 22 via a SAN (Storage Area Network) 26 of a structure which includes a FC (Fiber Channel) switch and the like. According to requests from the client terminal, the server 22 accesses the data stored in the disk array device 23, and replies to the client terminal 24 with processing results based upon the applications.

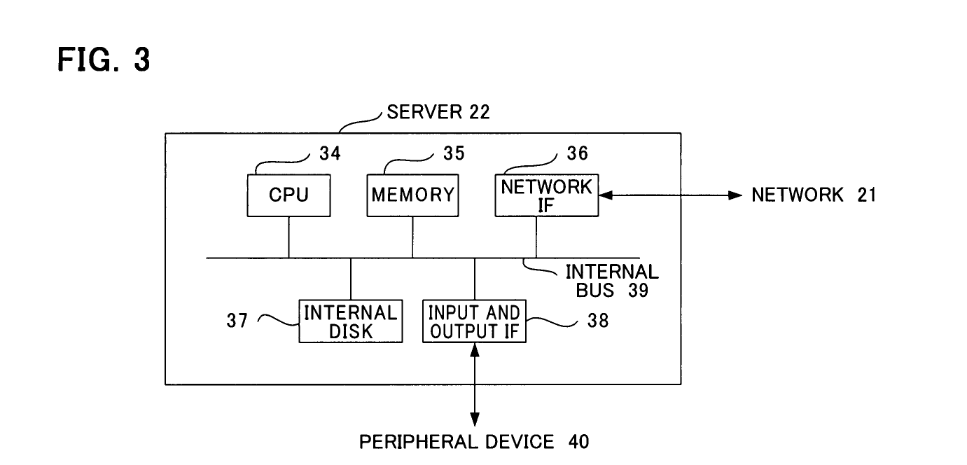

FIG. 3 is a figure showing an example of the structure of the server 22. The fundamental structure is the same as that of the client terminal 24 and the monitor terminal 25. The server 22 comprises a network interface 36 (a network IF) which processes communication via the network, a disk array device 23 which is connected to the server 22, an input and output IF 38 which processes data exchange with peripheral devices such as an FC switch and the like, an internal disk 37 upon which an OS and applications are installed, a memory 35 in which the OS and applications which have been read out for execution are stored, and in which data required for processing is stored, and a CPU 34 which controls various devices within the server 22 according to a program which is stored in the memory. The various devices within the server 22 are connected together by an internal bus 39.

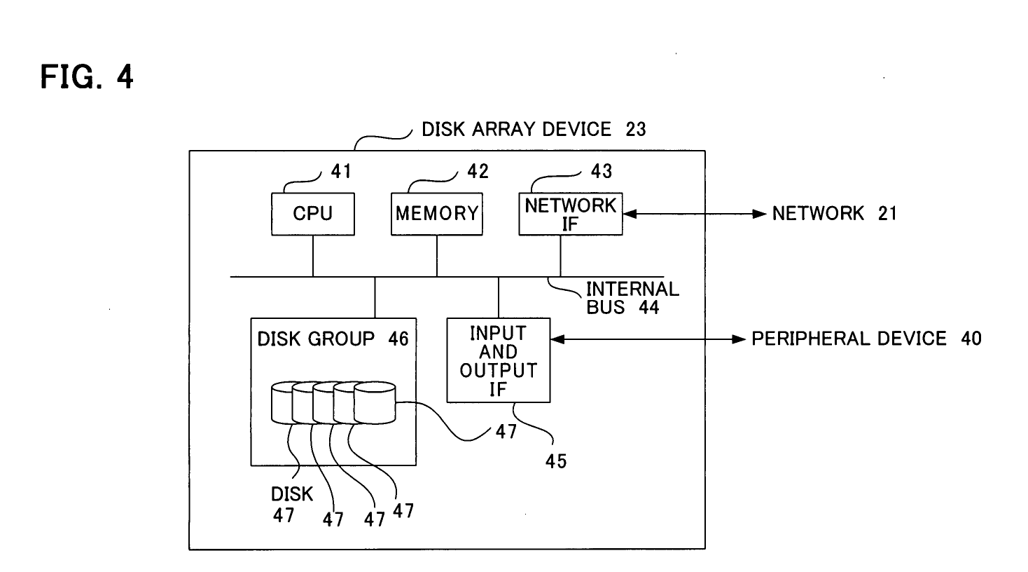

FIG. 4 is a figure showing an example of the structure of the disk array device 23. The disk array device 23 comprises a network IF 43 which processes communication via the network, an input and output IF 45 which processes data exchange with the server 22 and a peripheral device 40 such as an FC switch or the like which are connected to the disk array device 23, a disk group 46 which includes a plurality of disks 47 upon which data is stored, a memory 42 in which firmware, which is a program for controlling the disk array device 23, is stored, and in which data required for the processing is also stored, and a CPU 41 which controls the various devices within the disk array device 23 according to the firmware. The various devices within the disk array device 23 are connected together via an internal bus 44.

Next, the bottleneck detection method of an embodiment of the present invention will be explained. In the embodiment of the present invention, a reference point for the detection of bottlenecks is determined based upon a condition which is set in relation to the response time. And the history of the performance information before the reference point is referred to, and bottle necks are identified based upon an identification condition which is set in relation to the resource utilization ratio.

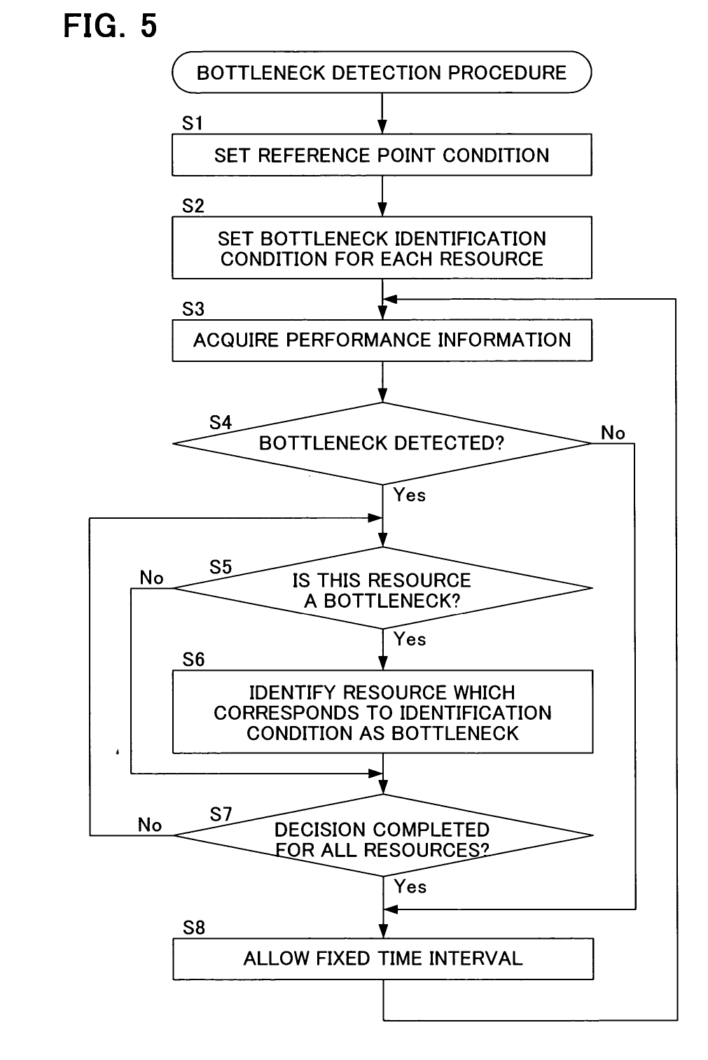

FIG. 5 is a flow chart for explanation of the bottleneck detection method according to an embodiment of the present invention. For example, the bottleneck detection method of the present invention may be implemented by executing a program which is stored in the memory 36 of the monitor terminal 25. Here, the situation when detecting bottlenecks on the disk array device using the monitor terminal of FIG. 2 will be explained with reference to the structural examples of the various devices shown in FIGS. 3 and 4.

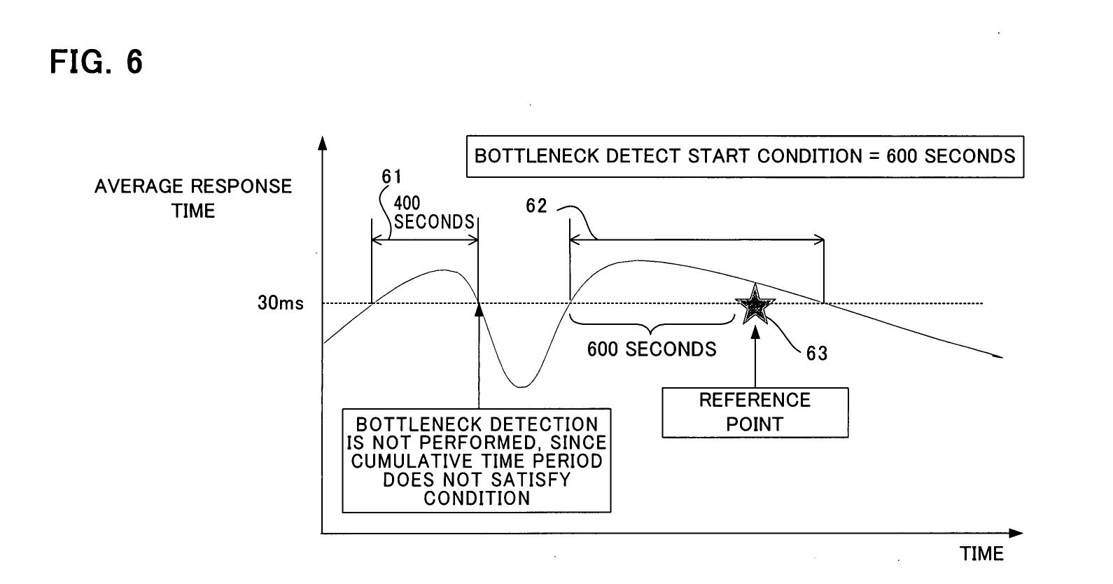

First, a condition (a reference point condition) related to the response time when setting a reference point for the detection of bottlenecks is set (S1) in the monitor terminal 25 of FIG. 2. In this embodiment, the detection of a bottleneck is performed by the response time satisfying the reference point condition, and the bottleneck is identified by referring to the history of the performance information before the reference point. As the reference point condition, for example, it is possible to set that the time period in which the average response time continuously exceeds a predetermined threshold value reaches a predetermined time period, or that, within a first predetermined interval, the cumulative time period of the intervals in which the average response time exceeds a first threshold value reaches a second predetermined time period, or the like. It should be understood that the reference point conditions will be described subsequently with reference to FIGS. 6 through 9.

These conditions are stored in advance in a storage means which is included in the monitor terminal 25, such as the memory 35 or the internal disk 37 or the like. For example, to each of a plurality of conditions, a number which identifies that reference point condition may be made to correspond, and this number may be stored in a variable which corresponds to the reference point condition. When this is done, it is possible to determine upon the reference point condition by reading out the number corresponding to the condition which has been stored in the variable. If there is only one condition, this condition may be used automatically.

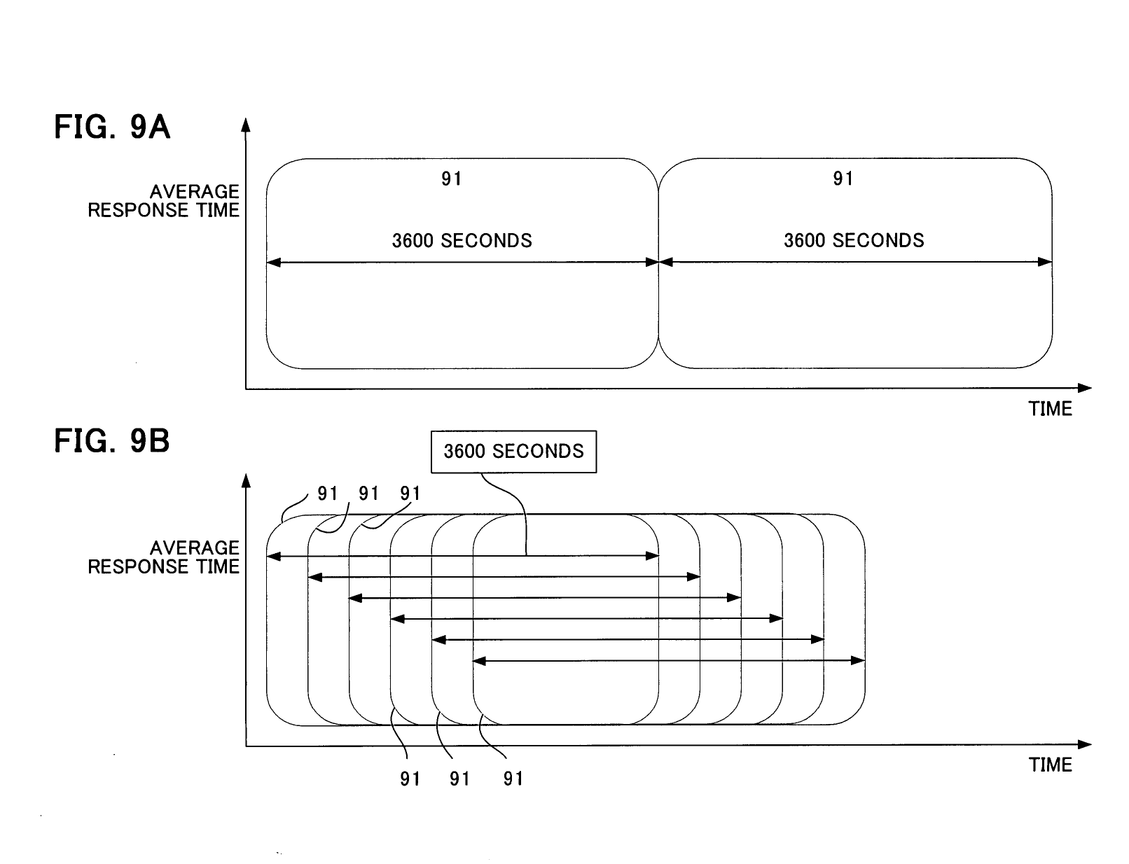

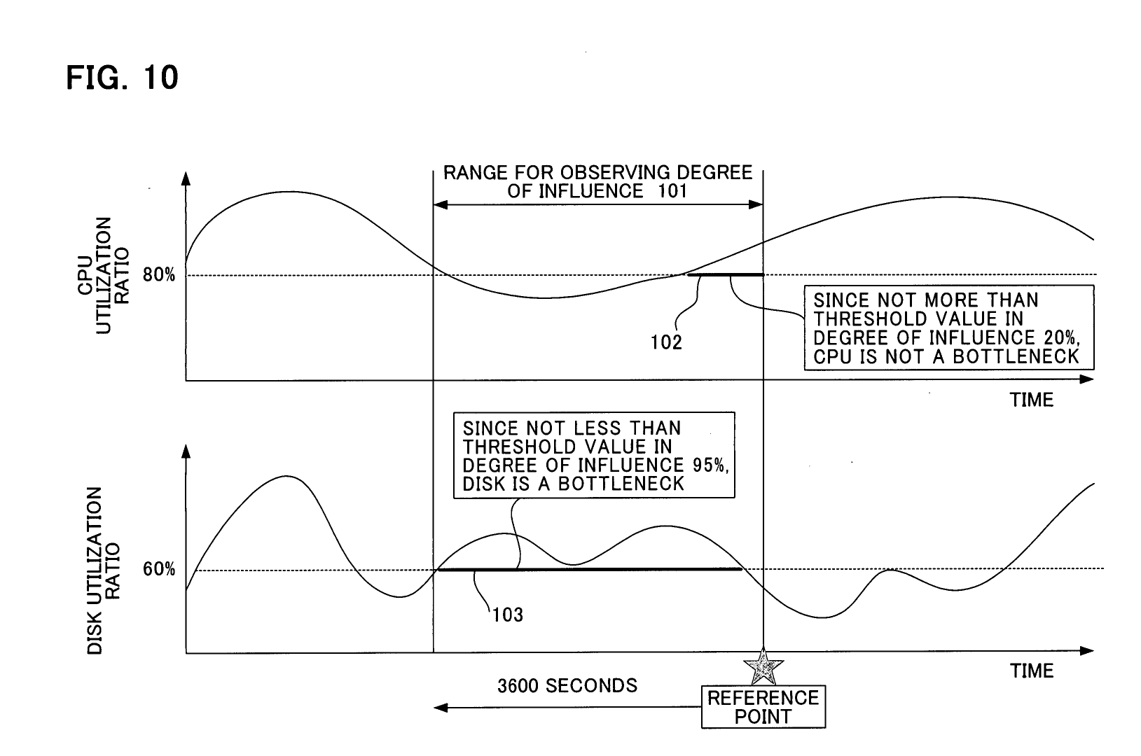

Next, for each of the resources included in the disk array device 23, a condition for identifying bottlenecks (an identification condition) is set (S2) in the monitor terminal 25. As such identification conditions, for example, being included in a predetermined interval, or that the proportion of intervals in which the utilization ratio for some resource has exceeded a predetermined threshold value set for that resource has exceeded a predetermined value, or the like, may be set. In the same manner as for the reference point conditions, a structure may be utilized in which this condition is stored as a variable in a storage means included in the monitor terminal 25, such as the memory 35 or the internal disk 37 or the like, and the identification condition may be determined by reading out this variable. It should be understood that the identification conditions will be described subsequently in FIGS. 9 and 10.

Next, performance information related to the disk array device 23 is acquired (S3) by the monitor terminal 25. By the CPU 41 in the disk array device 23 periodically executing its firmware, performance information which includes, at least, the number of IO requests, the IO response time, and the resource utilization ratios for the resources which are included in the disk array device 23 can be acquired and can be accumulated in a storage means such as the memory 42 or the like.

Furthermore, by installing a program which has a SNMP (Simple Network Management Protocol) agent function in the server 22 or the disk array device 23, and by installing a program which has a SNMP manager function in the monitor terminal 25, it is possible, via the network, for the monitor terminal 25 periodically to acquire the performance information which has been accumulated by the server 22 or the disk array device 23, and to store it in a storage means included in the monitor terminal 25, such as the internal disk 37 or the like. By doing this it is possible, in the step S3, for the monitor terminal 25 to acquire the performance information related to the disk array device 23.

And, based upon the performance information which has been acquired, the monitor terminal 25 makes a decision as to whether a bottleneck has been detected, and, when performing bottleneck detection, it determines (S4) a reference point. The bottleneck detection decision of the step S4 may be made by deciding whether the response time included in the performance information acquired in the step S3 satisfies the reference point condition which was set in the step S1. Concrete examples of this decision will be described subsequently in FIGS. 6 through 9.

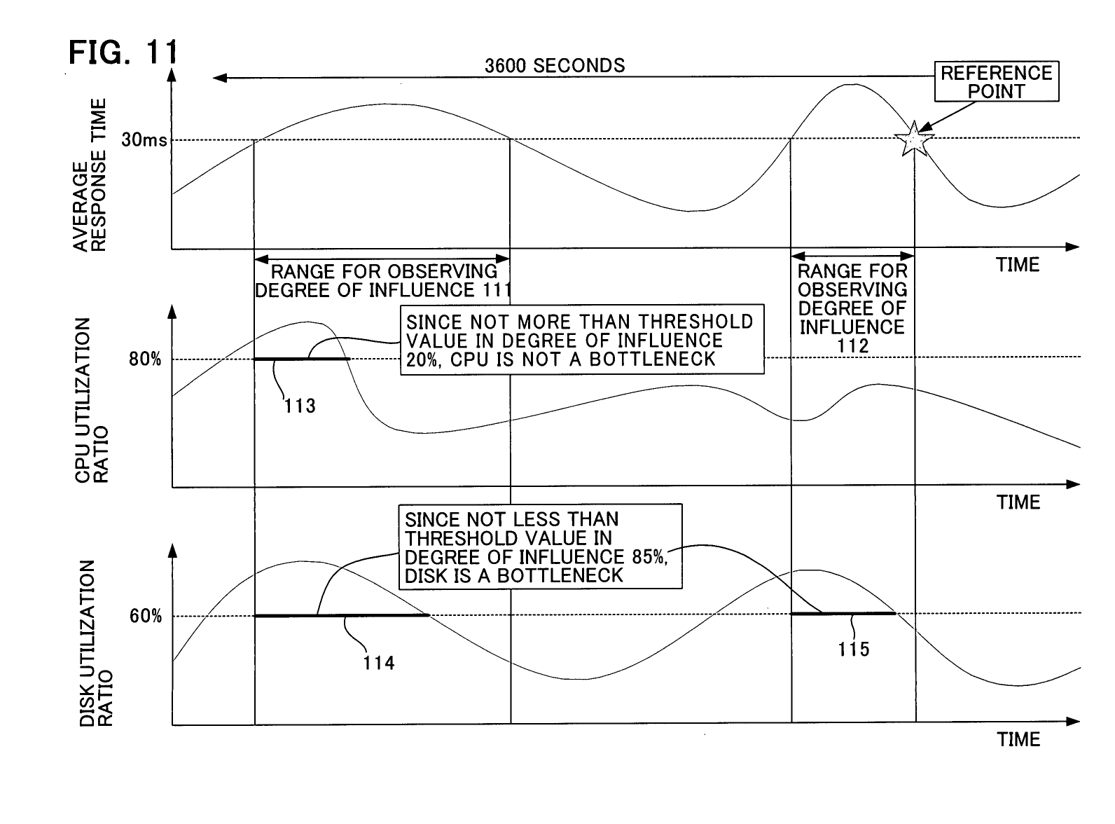

If the reference point condition in the step S4 is not satisfied, then control passes to the step S8, since no bottleneck detection procedure is to be performed, and, after waiting for a fixed time, the performance information is again acquired (S3), and the procedure of deciding whether a bottleneck is detected is repeated (S4). If at the step S4 the reference point condition is satisfied, then the time point at which the condition is satisfied is determined as the reference point, and a decision is made by the monitor terminal 25 for each of the resources, based upon the performance information acquired in the step S3, as to whether this resource is a bottleneck (S5). In the step S5, a decision may be made as to whether the resource utilization ratio for each of the resources, included in the performance information which has been acquired, satisfies the identification condition which was set in the step S2. Concrete examples of this decision will be described subsequently in FIGS. 10 and 11.

If the condition in the step S5 is satisfied, then this resource is identified as a bottleneck (S6) by the monitor terminal 25. After a resource which is a bottleneck has been identified, there are various possibilities for subsequent processing. For example: in the case of mail, the system administrator may be notified; the fact that this resource is a bottleneck may be displayed upon a display device, not shown in the figures, connected to the monitor terminal 25; and automatic processing may be performed. What is meant in concrete terms by automatic processing, for example, is that a CPU or a disk may be detached from the system structure, a disk may be stopped, or the cooling fan speed of a CPU may be increased.

If the condition in the step S5 is not satisfied, then a decision is made by the monitor terminal as to whether, for all of the resources which are included in the disk array device 23, the decision in the step S5 has been completed (S7). If, as yet, there is a resource for which this decision has not been performed (the “No” case in the step S7), then control returns to the step S5 and processing continues to be performed. If the decision of the step S5 has been completed for all of the resources (the “Yes” case in the step S7), then control proceeds to the step S8, and, after a fixed time has elapsed, the performance information is acquired again (S3), and a decision is made as to whether a bottleneck is detected (S4).

By the above bottleneck detection procedure, it is possible for the monitor terminal 25 periodically to acquire the performance information, and to perform detection of bottlenecks. What is used for making the decision as to whether a bottleneck has been detected is the response time, which increases together with the occurrence of a bottleneck, so that it becomes possible to perform the detection of bottlenecks more appropriately than in the prior art example of employing the resource utilization ratio, which does not necessarily accompany the occurrence of a bottleneck. Furthermore, what is used as a condition for identifying the bottleneck is the resource utilization ratio, so that, by employing the response time as the condition (the reference point condition) for implementing bottleneck detection, it becomes possible to perform the identification of bottlenecks more appropriately than in the prior art example of employing only just the performance information (the resource utilization ratio).

It should be understood that although, in the embodiments of the present invention, the situation has been explained in which the bottleneck detection procedure is executed by the monitor terminal 25, it may also be executed upon any terminal, provided that that terminal is connected to the disk array device 23 via the network 21. Accordingly this procedure may also be executed by the server 22, and, in this case, it is possible to employ the method of the present invention without introducing any new hardware.

Next, a number of examples of the reference point condition which is set in the step S1 will be explained. First, as a reference point condition, it is possible to set the fact that the time period over which the average response time has continuously exceeded a threshold value has reached a predetermined period.

FIG. 6 is a figure for explanation of this first reference point condition. The case in which a bottleneck detection procedure employing this condition is performed will now be explained, based upon the graph of FIG. 6 which shows an example of the average response time as it changes along with time.

In FIG. 6, 30 ms is employed as the threshold value, and 600 seconds is employed as the predetermined interval. In other words, if the time period over which the average response time exceeds 30 ms continues for 600 seconds, then the procedures of the step S5 and subsequently in FIG. 5 are started.

In FIG. 6, the first period in which the average response time continuously exceeds 30 ms is the section 61. However, the total interval (the cumulative time period) in this section 61 does not attain the predetermined interval of 600 seconds. Thus, in the section 61, detection of a bottleneck is not performed. Next, since in the section 62 in which the average response time continuously exceeds 30 ms, the state in which the average response time exceeds the threshold value continues for more than 600 seconds, accordingly the time point 63 at which the cumulative interval exceeds 600 seconds is determined upon as the reference point, and bottleneck detection is executed.

The fact that the time period over which the average response time has continuously exceeded the threshold value has reached the predetermined interval means that the high state of the average response time is being maintained, so that the possibility is high that a bottleneck is occurring. Accordingly, it is possible to detect bottlenecks more appropriately by setting the reference point condition in this manner.

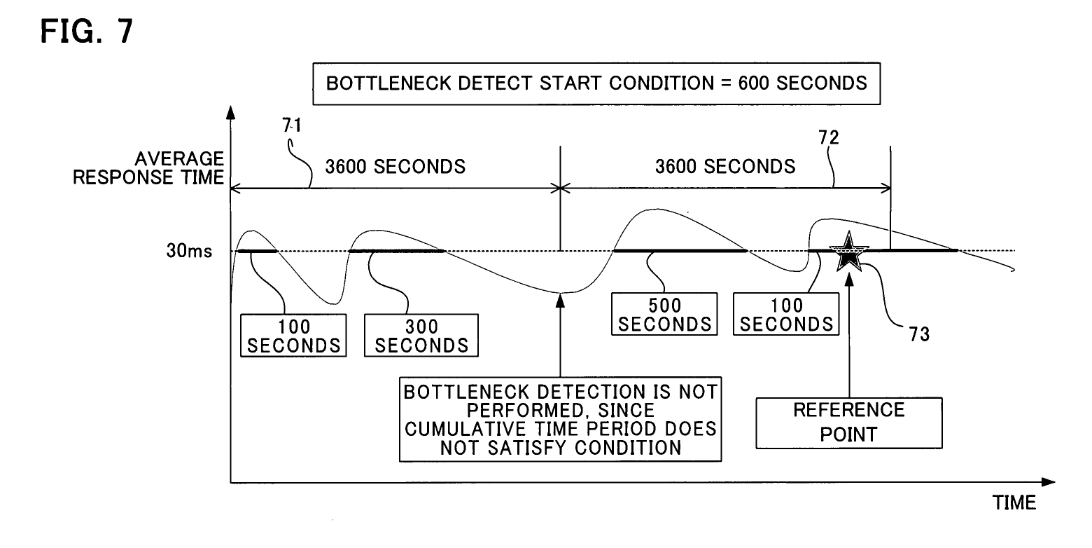

As another reference point condition, it is possible to set the fact that the total of the intervals (the cumulative interval) in which the average response time within a first predetermined interval exceeds some threshold value reaches a second predetermined interval. FIG. 7 is a figure for explanation of this second reference point condition. The case in which a bottleneck detection procedure employing this condition will now be explained, based upon the graph of FIG. 7 which shows an example of the average response time as it changes along with time.

In FIG. 7, 3600 seconds is employed as the first predetermined interval, 600 seconds is employed as the second predetermined interval, and 30 ms is employed as the threshold value. In other words, if the total of the intervals within 3600 seconds in which the average response time exceeds 30 ms reaches 600 seconds, then the procedures of the step S5 and subsequently in FIG. 5 are started.

In the first block 71 of 3600 seconds into which FIG. 7 has been divided, the total of the intervals in which the average response time exceeds 30 ms does not reach the second predetermined interval of 600 seconds. Thus bottleneck detection is not performed in this block 71. In the next 3600 seconds (block 72), when the cumulative interval exceeds 600 seconds, bottleneck detection is performed.

The fact that, within some interval, the total of the intervals in which the average response time has exceeded the threshold value has reached the (second) predetermined interval, means that the high state of the average response time is being maintained, so that the possibility is high that a bottleneck is occurring. Accordingly, it is possible to make the detection of bottlenecks more easy by setting the reference point condition in this manner. Furthermore, when the setting of FIG. 7 is made, bottleneck detection comes to be performed even in this case in which, with the setting of FIG. 6, bottleneck detection would not be performed since the sections in which the average response time continuously exceeds the threshold value are short, so that it is possible to enhance the bottleneck detection regime.

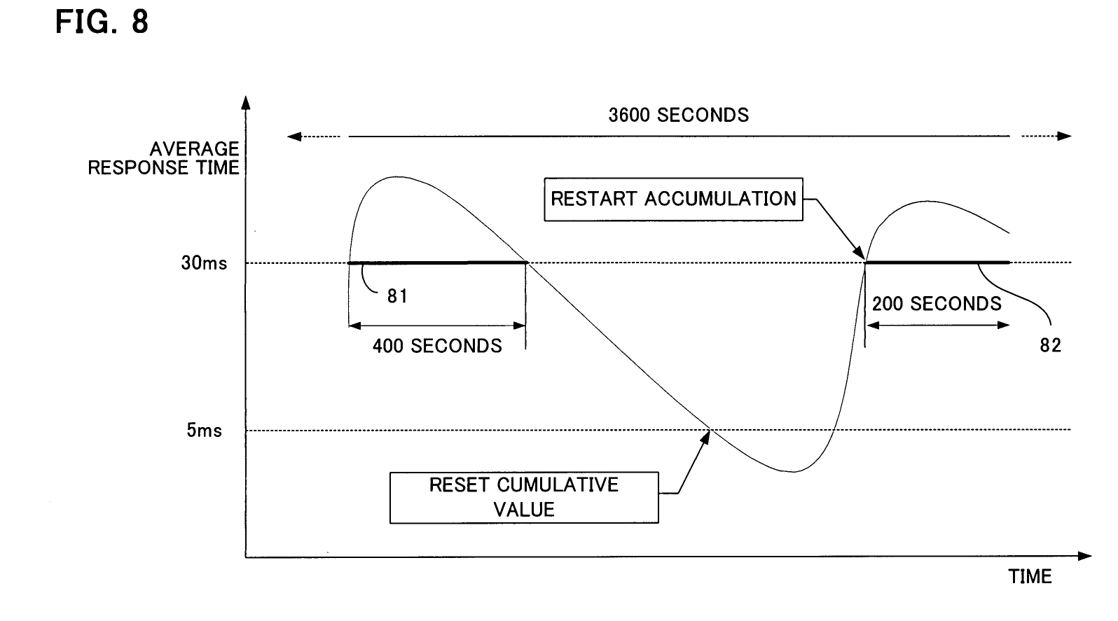

FIG. 8 shows a variant example of the method of calculating the cumulative interval in FIG. 7. Although, in FIG. 7, the intervals in which the average response time exceeds the threshold value are simply added together, FIG. 8 shows a method of calculating the cumulative interval in which a second threshold value is set which is lower than the first threshold value, and, if the average response time is less than this second threshold value, then the cumulative interval up to this point is set to zero.

FIG. 8 is a graph showing an example of the average response time varying along with time in some divided block of 3600 seconds. 5 ms is employed as the second threshold value. The other conditions are the same as in FIG. 7. Now, 400 seconds are accumulated in the section 81 in which the average response time exceeds the first threshold value (30 ms) . However, when thereafter the average response time drops below the second threshold value, the cumulative interval up until this point is reset to zero. After this, again, the section 82 in which the average response time exceeds the first threshold value continues for 200 seconds, but, since the cumulative value is reset, it does not reach the second predetermined time period (incidentally, if the cumulative interval had not been reset, this time point would have been determined as being the reference point, and bottleneck detection would have been performed).

If in FIG. 8 the average response time drops below the second threshold value, then this means that the average response time is fluctuating. Since if a bottleneck is occurring upon the disk array device 23 the state in which the average response time is high is maintained, accordingly, if fluctuations are occurring in the average response time, this means that there is a possibility that a bottleneck is occurring somewhere else than in the disk array device 23, so that, in the cumulative interval calculation method of FIG. 8, there is the beneficial effect of excluding this.

FIG. 9 is a figure for explanation of an example of the interval over which the cumulative interval is calculated. To put it in another manner, this is a figure for explanation of a variant example of the method of taking the first predetermined interval in FIG. 7. While, in FIG. 7, blocks were formed by dividing at each 3600 seconds, as a range for the first predetermined intervals (3600 seconds) not to mutually overlap, in FIG. 9, a case is shown in which the first predetermined interval is taken by shifting a block of 3600 seconds a little at a time.

FIG. 9A is a figure showing a method the same as that of FIG. 7. The blocks 91 of 3600 seconds are positioned so as not to mutually overlap. And, in FIG. 9B, the block 91 of 3600 seconds is positioned by being shifted a little at a time. The amount of this shifting may be uniform, or may be non-uniform. By taking the blocks as in FIG. 9B, it is possible to increase the number of times that the bottleneck detection procedure is performed, so that it is possible to enhance the accuracy of bottleneck detection yet further.

Next, the identification condition set in the step S2 will be explained by using several examples. It is possible to calculate the proportion occupied in a predetermined time period (the degree of influence) by the total of the intervals within that predetermined interval in which the resource utilization ratio exceeds a first threshold value, and to set, as the condition for identifying a bottleneck, that this proportion is greater than a predetermined value.

First, as one example of the predetermined interval, there is simply to take it as the time span from the reference point to a predetermined interval before it. The case in which the bottleneck decision procedure is specified by applying this condition will be explained, based upon the graph of FIG. 10 which shows an example of the average response time changing along with time.

In FIG. 10, 3600 seconds is employed as the predetermined interval. As for the threshold values for resource utilization ratio, which are to be set individually for each resource, 80% is employed as the threshold value for the CPU utilization ratio, whereas 60% is employed as the threshold value for the disk utilization ratio. And 80% is employed as the predetermined value for the degree of influence. In other words, within the interval from the reference point until 3600 seconds before it (the range over which the degree of influence is observed), if the total of the intervals in which the CPU utilization ratio exceeds 80% is not less than 80% of the entire range over which the degree of influence is observed, then the CPU is identified as a bottleneck; and, in the same manner, if the total of the intervals in which the disk utilization ratio exceeds 60% is not less than 80% of the entire range over which the degree of influence is observed, then the disk is identified as a bottleneck.

In FIG. 10 it will be understood that, from the reference point to 3600 seconds before it, the proportion which the section 102 in which the CPU utilization ratio exceeds 80% occupies in the range 101 over which the degree of influence is observed is 20%, while the proportion which the section 103 in which the disk utilization ratio exceeds 60% occupies in the range 101 over which the degree of influence is observed is 95% . Accordingly it is the disk, which exceeds the predetermined value (80%) set for the degree of influence, which is identified as being a bottleneck.

As another example of the predetermined interval, there is the possibility of making it be the time interval in which the average response time exceeds a second threshold value, in the history from the reference point up to a predetermined interval. Based upon the graph of FIG. 11, which shows an example of the change of the average response time along with time, the case of identifying a bottleneck by applying this condition will now be explained.

In FIG. 11, 30 ms is employed as the second threshold value. Apart from this, everything is the same as in FIG. 10. In FIG. 11, the time spans from the reference point up to 3600 seconds before it, and in which the average response time exceeds the second threshold value (30 ms), are picked out as the range over which the degree of influence is to be observed. When this is done, the two sections 111 and 112 meet this criterion.

And, it will be understood that the proportion in the range over which the degree of influence is to be observed (the sections 111 and 112) which the section 113 in which the CPU utilization ratio has exceeded 80% occupies in the range over which the degree of influence is to be observed (the sections 111 and 112) is 20%, and that the proportion in the range over which the degree of influence is to be observed (the sections 111 and 112) which the total of the time periods (the sections 114 and 115) in which the disk utilization ratio has exceeded 60% occupies is 85% . Accordingly the disk, which exceeds the predetermined value (80%) set for the degree of influence, is identified as being a bottleneck.

In the above, to summarize the embodiments of the present invention, a resource in which a bottleneck is identified is a resource for which, at the reference point, the response time is continuously in a high state, and also, before the reference point, the resource utilization ratio was in the high state. By doing this, i.e. by performing bottleneck detection based upon the response time, and by using the resource utilization ratio, which is different from the response time, as the identification condition, it is possible to perform identification of bottlenecks according to two criteria, so that it becomes possible to perform detection of bottlenecks more appropriately than in the prior art.

It should be understood that the numerical values used in the above described FIGS. 6 through 11 are only examples; they may be freely set to match the embodiment. Furthermore, the method by which the disk array device 23 and the server 22 are connected together is not limited to being a method via a SAN; it is also possible to apply the present invention, even if they are directly connected together using a SCSI (Small Computer System Interface) cable or the like.

Furthermore although, in the embodiments of the present invention, performance information which was accumulated in the disk array device was used in order to detect bottlenecks upon the disk array device 23, it would also be possible, alternatively, by the CPU 34 upon the server 22 periodically executing a command or the like which was provided in the OS, to acquire performance information including, at least, the number of IO requests, the IO response time, and the resource utilization ratios of the resources included in the disk array device 23, and to accumulate this performance information in a storage means such as the internal disk 37 or the like. Accordingly, it is also possible to utilize performance information which is accumulated by the server.

Moreover, the bottleneck detection method of the present invention may also be implemented by a program which is executed by the monitor terminal 25 or by the server 22.

Now additional variant examples will be explained of the reference point condition, which is the condition for starting bottleneck detection. In the reference point conditions explained in FIGS. 6 through 9, by way of example, cases were suggested where the time period over which the average response time continuously exceeded a predetermined threshold value reached a predetermined time period, or where the cumulative interval of the time periods in which, within a first predetermined interval, the average response time exceeded a first threshold value reached a second predetermined interval. However, here, bottleneck detection is started if the area of the portion in which the average response time exceeds a threshold value reaches a predetermined area, or if the area (the cumulative area) of the portions in which, within a predetermined interval, the average response time exceeds a threshold value reaches a predetermined area.

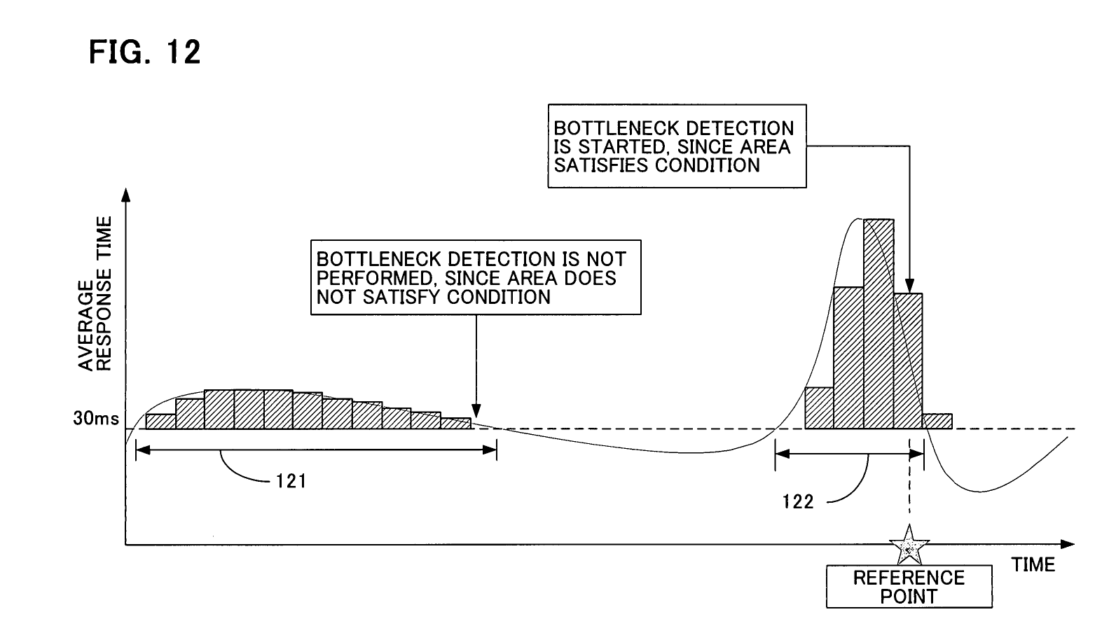

FIG. 12 is a figure for explanation of this third reference point condition. Based upon the graph of FIG. 12, which shows an example of the change of the average response time along with time, the case of executing a bottleneck detection procedure when the area of the portion in which the average response time continuously exceeds a threshold value reaches a predetermined area will now be explained.

In FIG. 12, 30 ms is used as the threshold value. In other words, if the area of the portion of the intervals in which the average response time exceeds 30 ms, which is surrounded by the average response time and by a horizontal line indicating 30 ms, which is the threshold value, reaches a predetermined area, the procedures of the step S5 of FIG. 5 and subsequently are started.

If the area of the portion surrounded by the average response time and a horizontal line indicating 30 ms, which is the threshold value, is expressed as a function of the average response time (including the case in which it is approximated by an approximate model), then it may be obtained as the integrated value from the start of the interval in which the average response time exceeds 30 ms to its end. Furthermore, as shown in FIG. 12, the area may also be obtained by approximating it by a rectangle for each of a number of small sections.

In FIG. 12, the section 121 is the one in which initially the average response time continuously exceeds 30 ms. However, the area which is calculated from the section 121 does not reach the predetermined area S. Thus, bottleneck detection is not performed in this section 121.

Next, the area which is calculated from the section 122 in which the average response time exceeds 30 ms exceeds the predetermined area. Accordingly, the final time point of this interval in which the average response time exceeds 30 ms is determined as the reference point, and the detection of a bottleneck is performed. It should be understood that, for the reference point, any time point of the interval in which the average response time exceeds 30 ms may be selected.

Although the interval in which the average response time exceeds the predetermined threshold value is short, if the magnitude of its response delay is great, then the possibility that a bottleneck will occur is high. When this area method is used, it is possible to start bottleneck detection, even if bottleneck detection would not be performed with the method shown in FIGS. 6 through 9 since the interval in which the average response time exceeds the predetermined threshold value is short. In other words, it is possible to start bottleneck detection if the response time is extremely slow even over a short time span; so that, by setting the reference point condition in this manner, it is possible to perform the detection of bottlenecks more appropriately.

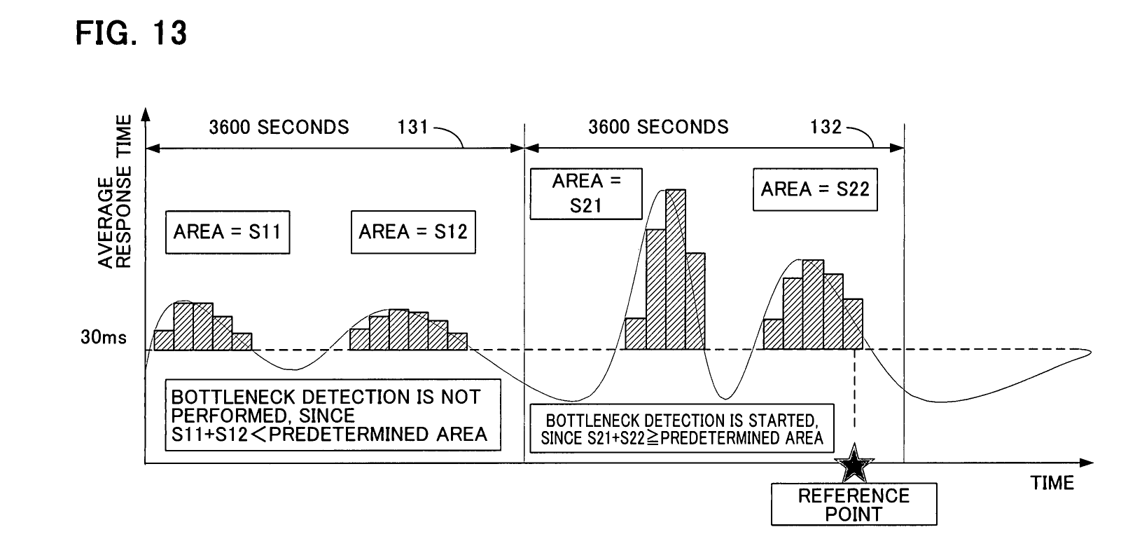

FIG. 13 is a figure for explanation of this fourth reference point condition. Based upon the graph of FIG. 13, which shows an example of the change of the average response time along with time, the case of executing the bottleneck detection procedure when the area of the portion in which, within a predetermined interval, the average response time exceeds a threshold value reaches a predetermined area will now be explained.

In FIG. 13, 3600 seconds is used as the predetermined interval, and 30 ms is used as the threshold value. In other words, if, in the interval in which, within 3600 seconds, the average response time exceeds 30 ms, the area of the portion which is surrounded by the average response time of the interval in which the average response time exceeds 30 ms and by a horizontal line indicating 30 ms which is the threshold value, reaches a predetermined area, then the procedures of the step S5 of FIG. 5 and subsequently are started.

In the initial separated block 131 of 3600 seconds in FIG. 13, the period at which the average response time exceeds 30 ms consists of two regions, and the areas of the portions which are surrounded by the average response time and by a horizontal line indicating 30 ms, which is the threshold value, are respectively S11 and S12. And their total (S11+S12) does not exceed the predetermined area. Thus, in this block 131, bottleneck detection is not execute.

In the next 3600 seconds (the block 132), the total (S21+S22) of the areas calculated from the intervals in which the average response time exceeds 30 ms becomes greater than the predetermined area. Accordingly, the final time point of the interval in which the average response time exceeds 30 ms is determined as the reference point, and bottleneck detection is performed. It should be understood that it would also be acceptable for any time point of the interval in which the average response time exceeds 30 ms to be selected as the reference point.

The fact that the total of the area calculated from the intervals in which, within some interval, the average response time exceeds the threshold value is greater than the predetermined area, suggests the possibility of the case occurring that the response time over a short time period is extremely slow, so that the possibility of a bottleneck occurring is high. Accordingly, it is possible to facilitate the detection of bottlenecks by setting the reference point condition in this manner. Furthermore, with the setting of FIG. 13, it is possible to enhance the accuracy of the detection of bottlenecks yet further, by performing bottleneck detection even in a case in which with the setting of FIG. 12 bottleneck detection is not performed, since the section in which the average response time continuously exceeds the threshold value is short.

With the reference point conditions shown in FIGS. 6 through 9, consideration is not given to the phenomenon of the threshold value (for example 30 ms) being greatly exceeded. In other words, while the possibility of the occurrence of a bottleneck is high if, although the interval in which the predetermined threshold value is exceeded is short, the magnitude of its response delay is large, a situation may transpire in which this cannot be appropriately detected. On the other hand, according to the reference conditions shown in FIGS. 12 and 13, it is possible to start bottleneck detection if the response time is extremely slow even over a short time period, so that it becomes possible to detect bottlenecks more appropriately.

Furthermore, as the calculation method for the cumulative area of FIG. 13, it would also be acceptable, as shown in FIG. 8, to provide a second threshold value (5 ms) which is lower than the first threshold value (for example 30 ms), and to calculate the cumulative area by, if the average response time is below this second threshold value, resetting the cumulative area up till this point to zero. Moreover, as shown in FIG. 9B, as the interval for calculating the cumulative area, it is also possible to take a predetermined interval by shifting a block of a predetermined length (for example 3600 seconds) little by little.

Even if an initial method of bottleneck detection based upon area, as shown in FIGS. 12 and 13, is employed, it would be possible, in the subsequent processing, to continue as in the case shown in FIG. 5 without any change. In other words, it would be acceptable to perform bottleneck decision as shown in FIGS. 10 and 11. Furthermore, it would be possible to obtain the same beneficial effects as with the embodiments shown in FIGS. 1 through 11, even with the variant examples shown in FIGS. 12 and 13.

### POSSIBILITIES OF UTILIZATION IN INDUSTRY

The bottleneck detection method of the present invention, for example, may be applied to a system in which a server which provides services to a client terminal via a network, and a disk array device which stores various data used by application programs operating upon that server, are connected together, or the like.

The range of protection of the present invention is not limited to the above described embodiments, but, rather, extends to the inventions described in the Patent Claims and their equivalents.

1. A system comprising: a server which provides a service to a client terminal via a network; a disk array device connected to said server and to said network and upon which data used by said server is stored; and a monitor terminal connected to said disk array device via said network, which detects a bottleneck on said disk array device; characterized in that
said disk array device or said server calculates and periodically notifies to said monitor terminal performance information including the number of IO requests issued from said server to said disk array device, the times required for processing the IO requests, and are source utilization ratio for each resource included in said disk array device; and
said monitor terminal takes, as a reference point, a time point at which an interval, in which an average response time obtained by dividing said processing time included in said periodically notified performance information by the number of said IO requests exceeds a first threshold value, exceeds a first predetermined interval; and identifies said resource as a bottleneck, if the proportion of intervals included in a second predetermined interval before said reference point, in which said resource utilization ratio exceeds a second threshold value set for each said resource, exceeds a predetermined proportion.

2. The system according to claim 1, characterized in that said monitor terminal takes, as the reference point, the time point at which the interval, in which said average response time exceeds said first threshold value, continuously exceeds said first predetermined interval.

3. The system according to claim 1, characterized in that said monitor terminal takes, as the reference point, the time point at which the result of accumulating for a third predetermined interval the intervals in which said average response time exceeds said first threshold value, exceeds said first predetermined interval.

4. The system according to claim 3, characterized in that said monitor terminal obtains said accumulated result for each said third predetermined interval.

5. The system according to claim 3, characterized in that said monitor terminal obtains said accumulated result over a space which is shorter than said third predetermined interval.

6. The system according to claim 3, characterized in that said monitor terminal resets back the cumulative interval to zero, if said average response time within said third predetermined interval has dropped below a third threshold value which is lower than said first threshold value.

7. The system according to claim 1, characterized in that said monitor terminal identifies said resource as a bottleneck, if the proportion of intervals, included in a fourth predetermined interval which is an interval before said reference point and moreover in which said average response time exceeds a fourth threshold value, and in which said resource utilization ratio exceeds said second threshold value set for each of said resources, exceeds said predetermined proportion.

8. A program executed by a terminal comprised in a system comprising a server which provides a service to a client terminal via a network, and a disk array device connected to said server and to said network and upon which data used by said server is stored, and connected to said disk array device via said network; characterized in that the program causes said terminal:
to receive performance information periodically notified by said server or said disk array device, including the number of IO requests issued from said server to said disk array device, the times required for processing the IO requests, and a resource utilization ratio for each resource included in said disk array device; and
to identify said resource as a bottleneck, with a time point at which an interval, in which an average response time, obtained by dividing said processing time included in said received performance information by the number of said IO requests, exceeds a first threshold value, exceeds a first predetermined interval, being taken as a reference point, if the proportion of intervals included in a second predetermined interval before said reference point, in which said resource utilization ratio exceeds a second threshold value set for each said resource, exceeds a predetermined proportion.

9. The program according to claim 8, characterized in that said reference point is the time point at which the interval, in which said average response time exceeds said first threshold value, continuously exceeds said first predetermined interval.

10. The program according to claim 8, characterized in that said reference point is the time point at which the result of accumulating for a third predetermined interval the intervals in which said average response time exceeds said first threshold value, exceeds said first predetermined interval.

11. The program according to claim 10, characterized in that said accumulated result is obtained for each said third predetermined interval.

12. The program according to claim 10, characterized in that said accumulated result is obtained over a space which is shorter than said third predetermined interval.

13. The program according to claim 10, characterized in that the cumulative interval is reset back to zero, if said average response time within said third predetermined interval has dropped below a third threshold value which is lower than said first threshold value.

14. The program according to claim 8, characterized in that said resource is identified as a bottleneck in a case where the proportion of intervals, included in a fourth predetermined interval which is an interval before said reference point and moreover in which said average response time exceeds a fourth threshold value, and in which said resource utilization ratio exceeds said second threshold value set for each of said resources, exceeds said predetermined proportion, rather than in a case where the proportion of intervals, included in a second predetermined interval before said reference point, and in which said resource utilization ratio exceeds a second threshold value set for each of said resources, exceeds a predetermined proportion.

15. A system comprising: a server which provides a service to a client terminal via a network; a disk array device connected to said server and to said network and upon which data used by said server is stored; and a monitor terminal connected to said disk array device via said network, which detects a bottleneck on said disk array device; characterized in that:
said disk array device or said server calculates and periodically notifies to said monitor terminal performance information including the number of IO requests issued from said server to said disk array device, the times required for processing the IO requests, and a resource utilization ratio for each resource included in said disk array device; and
said monitor terminal determines a time to become a reference point, based upon an interval in which an average response time, obtained by dividing said processing time included in said periodically notified performance information by the number of said IO requests, exceeds a first threshold value, and identifies said resource as a bottleneck, if the proportion of intervals included in a first predetermined interval before said reference point, in which said resource utilization ratio exceeds a second threshold value set for each said resource, exceeds a predetermined proportion.

16. The system according to claim 15, characterized in that said reference point is a time point at which the interval in which said average response time exceeds said first threshold value continuously exceeds a second predetermined interval.

17. The system according to claim 15, characterized in that said reference point is the time point at which the cumulative total, for a third predetermined interval, of the intervals in which said average response time exceeds said first threshold value, exceeds the second predetermined interval.

18. The system according to claim 15, characterized in that said reference point is the time point where, in an interval in which said average response time continuously exceeds said first threshold value, and arranging time on the horizontal axis and said average response time on the vertical axis, the area of a portion surrounded by a waveform obtained by plotting said average response time with respect to said time, and by a horizontal line showing said average response time having said first threshold value, exceeds a predetermined area.

19. The system according to claim 15, characterized in that said reference point is the time point where, in an interval in which said average response time exceeds said first threshold value, and arranging time on the horizontal axis and said average response time on the vertical axis, the total of accumulating, for a third predetermined interval, the areas of portions surrounded by a waveform obtained by plotting said average response time with respect to said time, and by a horizontal line showing said average response time having said first threshold value, exceeds a predetermined area.

20. The system according to claim 17 or claim 19, characterized in that said cumulative total is obtained for each said third predetermined interval.

21. The system according to claim 17 or claim 19, characterized in that said cumulative total is obtained over a space which is shorter than said third predetermined interval.

22. The system according to claim 17 or claim 19, characterized in that, in said monitor terminal, said cumulative total is reset back to zero, if said average response time within said third predetermined interval has dropped below a third threshold value which is lower than said first threshold value.

23. The system according to claim 15, characterized in that said monitor terminal identifies said resource as a bottleneck, if the proportion of intervals, included in a fourth predetermined interval which is an interval before said reference point and moreover in which said average response time exceeds a fourth threshold value, and in which said resource utilization ratio exceeds said second threshold value set for each of said resources, exceeds said predetermined proportion.

24. A program executed by a terminal comprised in a system comprising a server which provides a service to a client terminal via a network, and a disk array device connected to said server and to said network and upon which data used by said server is stored, and connected to said disk array device via said network; characterized in that the program causes said terminal:
to receive performance information, periodically notified by said server or said disk array device, including the number of IO requests issued from said server to said disk array device, the times required for processing the IO requests, and a resource utilization ratio for each resource included in said disk array device; and
to determine a time to become a reference point, based upon an interval in which an average response time, obtained by dividing said processing time included in said received performance information by the number of said IO requests, exceeds a first threshold value, and to identify said resource as a bottleneck, if the proportion of intervals included in a first predetermined interval before said reference point, in which said resource utilization ratio exceeds a second threshold value set for each said resource, exceeds a predetermined proportion.

25. The program according to claim 24, characterized in that said reference point is the time point at which the interval, in which said average response time exceeds said first threshold value, continuously exceeds said second predetermined interval.

26. The program according to claim 24, characterized in that said reference point is the time point at which the cumulative total, for a third predetermined interval, of the intervals in which said average response time exceeds said first threshold value, exceeds said second predetermined interval.

27. The program according to claim 24, characterized in that said reference point is the time point where, in an interval in which said average response time continuously exceeds said first threshold value, and arranging time on the horizontal axis and said average response time on the vertical axis, the area of a portion surrounded by a waveform obtained by plotting said average response time with respect to said time, and by a horizontal line showing said average response time having said first threshold value, exceeds a predetermined area.

28. The program according to claim 24, characterized in that said reference point is the time point where, in an interval in which said average response time exceeds said first threshold value, and arranging time on the horizontal axis and said average response time on the vertical axis, the total of accumulating, for a third predetermined interval, the areas of portions surrounded by a waveform obtained by plotting said average response time with respect to said time, and by a horizontal line showing said average response time having said first threshold value, exceeds a predetermined area.

29. The program according to claim 26 or claim 28, characterized in that said cumulative total is obtained for each said third predetermined interval.

30. The program according to claim 26 or claim 28, characterized in that said cumulative total is obtained over a space which is shorter than said third predetermined interval.

31. The program according to claim 26 or claim 28, characterized in that said cumulative total is reset back to zero, if said average response time within said third predetermined interval has dropped below a third threshold value which is lower than said first threshold value.

32. The program according to claim 24, characterized in that said resource is identified as a bottleneck, if the proportion of intervals, included in a fourth predetermined interval which is an interval before said reference point and moreover in which said average response time exceeds a fourth threshold value, and in which said resource utilization ratio exceeds said second threshold value set for each of said resources, exceeds said predetermined proportion.
